(19) United States
(12) Patent Application Publication
(10) Pub. No.: US 2002/0172215 A1
(43) Pub. Date: Nov. 21, 2002

(54) Fixed rate data slot scheduling

(76) Inventor: Ewa Barbara Hekstra-Nowacka, Eindhoven (NL)

Correspondence Address: U.S. Philips Corporation, 580 White Plains Road, Tarrytown, NY, 10591, US

(21) Appl. No.: 10/101,327

(22) Filed: Mar. 19, 2002

(30) Foreign Application Priority Data
Mar. 23, 2001 (EP) 01201097.1

(51) Int. Cl. H04J 3/16

(52) U.S. Cl. 370/437; 370/442

(57) ABSTRACT

Described is a method, wherein consecutive data slots (1, . . . N), which are located between a beginning and an end of a frame (1, . . . 4) included in a group of successive frames (1, . . . 4), are assigned to intra frame group defined data slot connections for establishing an upstream data transfer from one or more secondary stations (3-1, . . . 3-n) through a transmission channel (CH) to a primary station (2). The system may be a hybrid fiber coax data communication system. Several of such data slot connections between one or more secondary stations and the primary station are thus defined. Those data slots (1, . . . N) that are assigned to said data slot connections are concentrated, either at the beginning or at the end of the group of successive frames (1, . . . 4) by reallocating at least one data slot connection. The method makes an effective and well balanced use of the transmission channel by carrying out a reallocation of at least one data slot connection. The reallocation involves the termination of an existing data slot connection to be reallocated, and the rescheduling thereof in a next group of frames.

The present invention relates to a method wherein consecutive data slots, which are located between a beginning and an end of a frame included in a group of successive frames, are assigned to intra frame group defined data slot connections for establishing an upstream data transfer from one or more secondary stations through a transmission channel to a primary station.

The present invention also relates to a transmission system suitable for applying the method, a primary station suitable for such a transmission system, a secondary station suitable for such a transmission system, and to corresponding signals reflecting the operation of the above method.

Such a method and transmission system are known from a paper entitled: “A Protocol for Efficient Transfer of Data Over Hybrid Fiber/Coax Systems”, by J. O. Limb et al., IEEE/ACM Transactions on Networking, Vol. 5, No. 6, December 1997, pages 872-881. The known transmission system comprises a Head-end, as a primary station and a plurality of secondary stations, comprising data modems. Primary and secondary stations are coupled through a coax-fiber transmission medium, comprising a downstream channel for high-speed data transfer from the primary station to the secondary stations, and an upstream channel for data transfer from one or more secondary stations to the primary station. After a request-grant that typically uses a contention procedure a contention free transmission is granted in a free upstream data slot connection. In particular upstream transmission has to be governed by a protocol that exploits the medium efficiently over a range of transmission speeds, say 1-100 Mbits/s, and over relatively long distances, up to 35 km. Thereto data slots are included in successively grouped frames, that are sent by each of the secondary stations through the established data slot connections to the primary station. It is also important as stated in the paper, that fixed-rate upstream data transfer is being supported by the method implemented by the protocol.

However this aspect is not addressed in this prior art paper.

Therefore it is an object of the present invention to provide a method for scheduling transfer of data slots, which supports fixed rate upstream data transfer, and nevertheless makes an efficient use of the available upstream channel in the transmission system.

Thereto the method according to the invention is characterized in that those data slots that are assigned to said data slot connections are concentrated, either at the beginning or at the end of the group of successive frames by reallocating at least one data slot connection.

It is an advantage of the method according to the present invention that by concentrating unused data slots—which are those data slots to which no data slot connection is assigned—either at the beginning or at the end of frames in the group of frames, conformance to specific guidelines and standards can be achieved. For example taking into account the Digital Video Broadcast (DVB) guidelines it is possible to schedule the intra frame group defined data slot connections at the end of frames within the group of frames, such that a more efficient use of the available upstream channel can be made. Intra frame group defined data slot connections here stand for data slot connections that extend over one or more of the frames within the same group of frames. With the present invention also a possible imbalance of the sizes of the used data slots in a region near the ends of the frames in the group of frames is effectively limited, as a result of which approximately the same number of used data slots per frame is more or less guaranteed. By further advantageously proposing a reallocation of data slot connections a continuous optimization is achieved of both the use of the upstream channel, and the reduction of said imbalance.

Conversely, if sufficient data slots are available, which can easily be checked by a simple connection admission control, the scheduling of the reallocation of data slot connections can be performed freely. Furthermore, if most unused data slots are expelled from in particular the beginning or the end of the frames the number of reallocations of data slot connections can be kept to a minimum over time. In addition, this minimizes any messaging and transmission load of the transmission channel between the primary station and any of the plurality of secondary stations or vice versa.

It is further noted here that any assignment of data slots to intra frame group defined data connections and any handling necessary for such assignment is restricted to data slots within a frame that belongs to a group of frames. The data is transmitted in the slots resulting from repeating the slot assignments associated with that group of frames. Such handling and associated scheduling within the group is also repeated, and if there are no reallocations of data slot connections to be made no rescheduling is needed and a previously calculated local schedule can be used repeatedly. This makes the method very efficient.

An embodiment of the method according to the invention is characterized in that the intra frame group defined data slot connections are fixed rate connections having a constant rate expressed in number of slots per number of successive frames in a group, which rate is represented in the form {1/n^{k}} with k=0, 1, 2, . . . , K, with n and K fixed.

Advantageously the fixed rate connections that will be evenly spread over the available data slots and are therefore periodic, can be freely scheduled over the data slots in successive frames within a group of n^{K} frames, that is as long as there is no conflict in data slot assignment. If for example n=K=2 the following sets of data rate connections are possible, viz. 1, ½, ¼ rate with 1 data slot per frame, 1 data slot per 2 frames, and 1 data slot per 4 frames respectively, in which case one group of frames encompasses four frames.

A further embodiment of the method according to the invention is characterized in that the reallocation of the at least one data slot connection is event driven.

So if no events occur no reallocation takes place and the same local schedule can advantageously be used for every group of frames. The events driving the reallocation in particular concern the adding or terminating of at least one data slot connection, and these events are well defined within the group of frames.

A still further embodiment of the method according to the invention is characterized in that the reallocation involves the termination of an existing data slot connection to be reallocated, and the rescheduling thereof in a next group of frames. Advantageously this embodiment of the method according to the invention involves a predictable two step process of termination and rescheduling.

Another embodiment of the method according to the invention, is characterized in that, if corresponding ends of the frames in a group of frames are modeled to be stacked side by side such that data slots form equally numbered rows from beginning to end respectively of the frames, that starting from the end of the frames a main layer can be defined comprising rows of data slots in the group of frames which are completely assigned to data connections, except the row of the main layer having the lowest data slot or row number which is defined as an intermediate layer, that a contour layer can be defined as those row or rows not comprising completely assigned data slots, and that the layers are being used for scheduling and/or rescheduling the data slot connections.

Advantageously if unused data slots, that is as noted above, data slots that are not assigned to a data slot connection, are to be converted to assigned data slots due to adding a new data slot connection or terminating an existing data slot connection in the contour layer then reallocation takes place in said contour layer, and does not involve any reallocation actions in completely assigned layers such as the intermediate layer and/or the main layer. This simplifies the allocation handling and control and such an approach can therefore simply be implemented by means of a state machine, which uses enumerated states and transitions for the limited contour space involved. The elimination of unused data slots can take place at the lowest costs of reallocations, which is guaranteed by not affecting the lower completely assigned intermediate and main layer.

In addition, if a new row completely assigned to data slot connections is created while operating on the contour, it becomes a new the intermediate layer, and the former intermediate layer is appended to the main layer. The former content of the main layer is advantageously not changed.

At present the method and transmission system according to the invention will be elucidated further together with their additional advantages, while reference is being made to the appended drawing, wherein similar components are being referred to by means of the same reference numerals.

In the drawings:

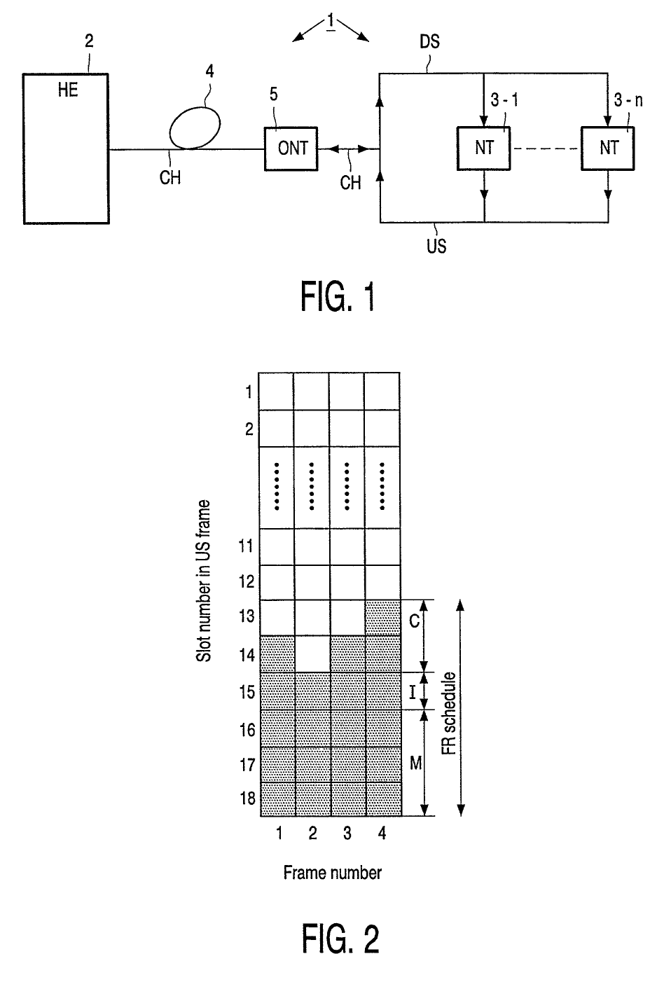

FIG. 1 shows an embodiment of a transmission system, wherein the method according to the invention is implemented;

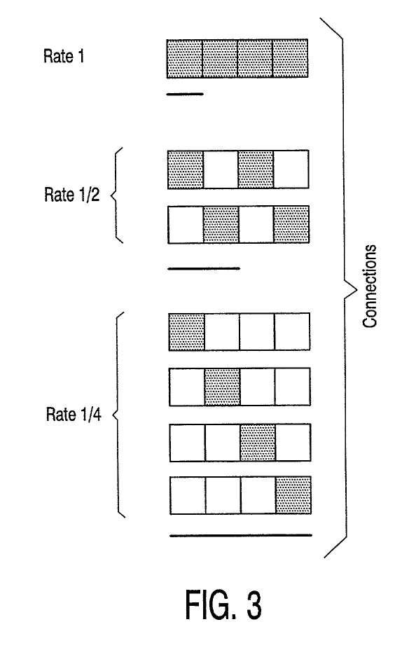

FIGS. 2 and 3 show graphical representations for explaining the method to schedule the transfer of data slots included in frames.

FIG. 1 shows a transmission system 1 having a primary station 2, also called Head End (HE) and a plurality of secondary stations 3-1, . . . 3-n, also called Network Terminals (NT) which are coupled through a data channel CH to the primary station 2. The system 1 as shown is a HFC/CATV system having a fiber link 4 and an Optical Network Terminator (ONT) 5 by which through a Down Stream (DS) data channel part and an Up Stream (US) data channel part, HE 2 and NTs 3, and/or NTs mutually (via HE) are capable of communicating over the data channel CH by making a connection, hereafter called data slot connection. Such a connection is established through the use of one or more time slots, which will be explained hereafter. Time slots are included in each frame, and as far as they are meant to transfer data they are called data slots hereinafter.

Just by way of example the system 1 may be a Digital Video Broadcast (DVB)/Digital Audio Video Council (DAVIC)-compliant network with for example N=1000 NTs and an US channel with a gross capacity of 3,088 Mbit/s. Each frame may consist of 18 consecutive data slots and then lasts approximately 3 ms. Successive frames each containing 18 data slots are represented in FIG. 2 and show graphical representations of a group of four frames. The model as shown therein represents a bin, wherein the frames are stacked side by side. The bin represents a group of here four frames, which are continuously transferred over the transmission channel CH. Frames are numbered 1, 2, 3, . . . , n^{K}, here with n=K=2, and each upstream (US) frame consists here of several data slots, numbered 1, 2, . . . 18. Correspondingly numbered data slots are included in the same row in the bin. The data slots indicated black in FIG. 2 are assigned to a data slot connection, and may be filled with data by means of data cells fitting in these data slots. Data cells not assigned to a data slot connection are left blank in FIG. 2.

As shown in FIG. 2 unused blank data slots in the frames 1-4 in the group of four frames are being expelled from beginnings—at data slot 1—or ends—at data slot 18—of the frames. The frames are grouped in a group of frames, and each group comprises four frames. Of course a different number of frames may be applied in the method for scheduling data slot connections, which are multiples of n^{K}, and a frame may have any fixed number of data slots in an embodiment concerned. The used data slots are concentrated here at the ends of the frames 1-4 at data slots 18, 17, 16, 15, which is advantageous in relation to DVB standards. This preserves upstream channel capacity. Used data slots are also located in slot 14 in frames 1 and 3, as well as in slots 13 and 14 in frame 4. The used upstream data slots serve to establish connections from one or more secondary stations 3-1, . . . 3-n to the primary station 2. There may be some imbalance in the sizes of the used data slots in a region near the ends of the frames in the group, but this can be effectively limited by proper reallocation of used data slots. The result of the reallocation is, that approximately the same amount of data slots per frame are covered by used data slots.

As elucidated in FIG. 3 there are several types of data slot connections. In the case wherein a group comprise four frames there are three different types of connections, where data slots are evenly spread over the frames in the group of frames. Therefore there are rate 1, rate ½, or rate ¼ data slot connections. A rate 1 data slot connection uses 4 data slots, for example four slots 18 in the consecutive frames 1, 2, 3 and 4 within the group of four frames. There are two kinds of rate ½ data slot connections as shown, using either data slots in frames 1 and 3, or data slots in frames 2 and 4. These aforementioned data slots lie in equally numbered data slots, such that for example slots 16 of frames 1 and 3 contain data concerning the same data slot connection between some secondary station 3 and the primary station 2. The same holds for data slots 2 and 4. There are four kinds of rate ¼ data slot connections, using either of the data slots, equally numbered in frames 1, 2, 3 or 4. In the example given above the rate 1 connection using one slot per frame has a bit rate of 128 kb/s, the rate ½ connection using one slot per two frames has a bit rate of 64 kb/s, while the rate ¼ connection using one slot per four frames has a bit rate of 32 kb/s.

In the most general case the intra frame group defined data slot connections are fixed rate connections having a constant rate expressed in number of slots per number of successive frames in a group. The rate may then be represented by the form {1/n^{k}} with k=0, 1, 2, . . . , K, with n and K fixed. The data slots are evenly spread over the upstream data transfer, so the rate 1/n^{k} translates into 1 data slot per n^{k} consecutive frames. In the case described in the preceding paragraph it holds that: n=K=2. If each frame in the general case has a arbitrary number of slots N, the distance between subsequent slots of the data slot connection having rate 1/n^{k} equals n^{k}×N. This in fact implies that in every frame in which a data slot for a data slot connection must be assigned in order to comply to its rate, this data slot appears in the same position within the frame. Such a data slot connection is therefore called a fixed rate data slot connection. If a data slot of a data slot connection does not appear in the same position within the frame then this is called a non fixed rate data slot, and such data slots will be eliminated as will be explained hereafter.

Each of the aforementioned data slot connections can be reallocated—if necessary—to use unused data slots at the beginning or at the end the frames in a group. It is important to reduce the number of allocations as much as possible, in order to minimize the message load on the transmission channel CH. The reallocation is therefore event driven. Events related to the reallocation are the termination of a data slot connection, and the addition thereafter of a new data slot connection. Normally the reallocation of a data slot connection involves the termination of an existing data slot connection, which is to be reallocated, followed by the addition and rescheduling of the data slot connection at a new position in the frames of a group. In general the new data slot connection will be provided at the location of gaps formed by one or more unused data slots.

In FIG. 2 several data slot connections having different rates described above are represented by black blocks. One method of scheduling data slots uses the concept of a contour layer C, which is the top layer of data slot connections at the end of the frames in the group. This contour layer C, if not empty, comprises all partially scheduled rows of data slots used for a fixed rate data slot connection. The maximum height in terms of rows of the contour layer relates to the allowed imbalance of the data rate connection schedule. At the end of the frames in the group there is the main layer M, which if not empty, comprises all completely scheduled rows, except the “highest” of the rows which is completely scheduled and is called the intermediate layer I.

In the embodiment of FIG. 2 the contour layer C includes data slot numbers 13 and 14 in the group 1-4. This contour layer C has unused data slots, such as data slots 13 of frames 1, 2 and 3, and slot 14 of frame 2. The intermediate layer I includes row 15, that is data slots 15 of frames 1-4, and the main layer M is similarly formed by rows 16-18.

The method for scheduling the data slot connections uses these layers C, I, and/or M for optimization purposes. In particular a minimum number of reallocations over time of fixed rate data slot connections already established is required, in order to minimize any messaging and transmission load over the transmission channel CH. At the other hand as explained above non fixed rate data slot connections are to be eliminated from the layers C, I and M.

When for example a data slot connection is added, it is first placed in the contour layer C, where after a data slot connection reallocation is performed and, as far as necessary an upgrade of the layers is made. At the other hand when a data slot connection is terminated, the possible non fixed rate data slots of a connection—created due to a connection termination—within groups of fixed rate slots aligned to the end of the frames, are eliminated using connection reallocations. Advantageously connection reallocations serving the elimination of non fixed rate slots only concern a limited number of data slot connections depending on the specific location of the non fixed rate data slot to be eliminated. In particular if the non fixed rate data slot to be eliminated is located:

in the contour layer C, then only other data slot connections in the contour C may be involved in the reallocation, and data slot connections in the completely scheduled intermediate and main layer are not influenced thereby;

in the intermediate layer I, then only other data slot connections in the contour C and/or the intermediate layer I are involved in the reallocation, and data slot connections in the completely scheduled main layer are not influenced thereby;

in the main layer M, then data slot connections in the contour and in the intermediate layer are involved, together with data slot connections to which data slots are assigned that reside on the same data slot row or position as the slot position of the terminated data slot connection.

The concept set out in the above opens new ways of developing strategies for making optimal use of available channel transmission capacity. In particular contour C shapes, content type of the contour layer C, and completely scheduled rows pertaining to inter layer I and main layer M can be enumerated by an objective and predictable determination, because of the limited sets of data slot connection rates. This in turn permits an efficient implementation of contour layer changes as a simple state machine. Even an expectation can be made about an optimized strategy concerning the planning of transitions and reallocations of separate data slot connections or structures and groups of data slot connections, now and in the future. Contour C subspace can be restricted and/or controlled and related to a permitted imbalance. The control circuitry and protocol software necessary for implementing the method is advantageously mainly present in the primary station 2 only.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person.

1. A method wherein consecutive data slots (1, . . . N), which are located between a beginning and an end of a frame (1, . . . 4) included in a group of successive frames (1, . . . 4), are assigned to intra frame group defined data slot connections for establishing an upstream data transfer from one or more secondary stations (3-1, . . . 3-n) through a transmission channel (CH) to a primary station (2), characterized in that those data slots (1, . . . N) that are assigned to said data slot connections are concentrated, either at the beginning or at the end of the group of successive frames (1, . . . 4) by reallocating at least one data slot connection.

2. The method according to claim 1, characterized in that the intra frame group defined data slot connections are fixed rate connections having a constant rate expressed in number of slots per number of successive frames in a group, which rate is represented in the form {1/n^{k}} with k=0, 1, 2, .,K, with n and K fixed.

3. The method according to one of the claim 1 or 2, characterized in that the reallocation of the at least one data slot connection is event driven.

4. The method according to claim 3, characterized in that the event concerns the adding or terminating of at least one data slot connection.

5. The method according to one of the claims 1-4, characterized in that the reallocation involves the termination of an existing data slot connection to be reallocated, and the rescheduling thereof in a next group of frames.

6. The method according to claim 4 or 5, characterized in that, if corresponding ends of the frames in a group of frames are modeled to be stacked side by side such that data slots (1, . . . 18) form equally numbered rows from beginning (1) to end (18) respectively of the frames, that starting from the end (18) of the frames a main layer (M) can be defined comprising rows of data slots in the group of frames which are completely assigned to data connections, except the row of the main layer having the lowest data slot or row number which is defined as an intermediate layer (I), that a contour layer (C) can be defined as those row or rows not comprising completely assigned data slots, and that the layers (M, I, C) are being used for scheduling and/or rescheduling the data slot connections.

7. A transmission system (1) for executing the method according to one of the claims 1-6, wherein consecutive data slots (1, . . . N), which are located between a beginning and an end of a frame (1, . . . 4) included in a group of successive frames (1, . . . 4), are assigned to intra frame group defined data slot connections for establishing an upstream data transfer from one or more secondary stations (3-1, . . . 3-n) through a transmission channel (CH) to a primary station (2), characterized in that the transmission system (1) is equipped for concentrating those data slots (1, . . . N) that are assigned to said data slot connections, either at the beginning or at the end of the group of successive frames (1, . . . 4) by reallocating at least one data slot connection.

8. A primary station (2) suited for application in the transmission system (1) according to claim 7, wherein consecutive data slots (1, . . . N), which are located between a beginning and an end of a frame (1, . . . 4) included in a group of successive frames (1, . . . 4), are assigned to intra frame group defined data slot connections for establishing an upstream data transfer from one or more secondary stations (3-1, . . . 3-n) through a transmission channel (CH) to a primary station (2), characterized in that the primary station (2) is equipped for concentrating those data slots (1, . . . N) that are assigned to said data slot connections, either at the beginning or at the end of the group of successive frames (1, . . . 4) by reallocating at least one data slot connection.

9. A secondary station (3-1, . . . 3-n) suited for application in the transmission system (1) according to claim 7, wherein consecutive data slots (1, . . . N), which are located between a beginning and an end of a frame (1, . . . 4) included in a group of successive frames (1, . . . 4), are assigned to intra frame group defined data slot connections for establishing an upstream data transfer from one or more secondary stations (3-1, . . . 3-n) through a transmission channel (CH) to a primary station (2), characterized in that the secondary station (3-1, . . . 3-n) is equipped for concentrating those data slots (1, . . . N) that are assigned to said data slot connections, either at the beginning or at the end of the group of successive frames (1, . . . 4) by reallocating at least one data slot connection.

10. Signals for use in the transmission system (1) according to claim 7 to execute the method according to one of the claims 1-6.
